(19) United States
(12) Patent Application Publication
(10) Pub. No.: US 2017/0063722 A1
(43) Pub. Date: Mar. 2, 2017

(54) MANAGING A SHARED POOL OF CONFIGURABLE COMPUTING RESOURCES WHICH HAS A SET OF CONTAINERS

(71) Applicant: Internation Business Machines Corporation, Armonk, NY (US)

(72) Inventors: Joseph W. Cropper, Rochester, MN (US); Jeffrey W. Tenner, Rochester, MN (US)

(21) Appl. No.: 14/866,758

(22) Filed: Sep. 25, 2015

Related U.S. Application Data
(63) Continuation of application No. 14/839,821, filed on Aug. 28, 2015.

(51) Int. Cl. H04L 12/911; G06F 9/455; G06F 9/50

(52) U.S. Cl. CPC H04L 47/82; G06F 9/50; G06F 9/45558

(57) ABSTRACT

A shared pool of configurable computing resources is managed. The shared pool of configurable computing resources has a set of physical hosts, a set of virtual machines, and a set of containers. A set of resource usage data for the set of containers is monitored to detect a triggering event which corresponds to the set of resource usage data. Using the set of resource usage data, a container arrangement is determined. The container arrangement indicates a relationship with respect to the set of containers, the set of virtual machines, and the set of physical hosts. In response to both determining the container arrangement and detecting the triggering event, the container arrangement is established.

### BACKGROUND

This disclosure relates generally to computer systems and, more particularly, relates to managing a shared pool of configurable computing resources which has a set of containers. The amount of data that needs to be managed by enterprises is increasing. Management of a shared pool of configurable computing resources may be desired to be performed as efficiently as possible. As data needing to be managed increases, the need for management efficiency may increase.

### SUMMARY

Aspects of the disclosure manage a shared pool of configurable computing resources. The shared pool of configurable computing resources has a set of physical hosts, a set of virtual machines, and a set of containers. A set of resource usage data for the set of containers is monitored to detect a triggering event which corresponds to the set of resource usage data. Using the set of resource usage data, a container arrangement is determined. The container arrangement indicates a relationship with respect to the set of containers, the set of virtual machines, and the set of physical hosts. In response to both determining the container arrangement and detecting the triggering event, the container arrangement is established.

Disclosed aspects include operations for placement or ongoing performance benefits related to software containers in a cloud environment. Features may relate to cloud management software which monitors the utilization (e.g., memory, processing, input/output) and health of containers so that resources can be efficiently utilized and the effects of failures may be at least partially averted for the container. Disclosed aspects can move one or more containers to another virtual machine running the same container technology within a cluster of virtual machines to have positive impacts such as resource usage or failure avoidance. As new hosts are added to the host cluster, as container resource requirements change, or when failures are predicted, the movement of containers can be initiated to benefit the availability or performance of containers. Aspects of the disclosure can manage multiple container engine technologies. Such capabilities can be integrated into a cloud virtualization management model such that virtual machines for container engines may benefit from placement and maintenance/optimization technologies integrated into the cloud management software.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a cloud computing node according to embodiments.

FIG. 2 depicts a cloud computing environment according to embodiments.

FIG. 3 depicts abstraction model layers according to embodiments.

FIG. 4 is a flowchart illustrating a method for managing a shared pool of configurable computing resources having a set of physical hosts, a set of virtual machines, and a set of containers according to embodiments.

FIG. 5 shows an example system having a set of virtual machine hosts, a set of virtual machines, and a set of containers according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the disclosure include operations for placement or ongoing performance benefits related to software containers in a cloud environment. Features may relate to cloud management software which monitors the utilization (e.g., memory, processing, input/output) and health of containers so that resources can be efficiently utilized and the effects of failures may be at least partially averted for the container. Disclosed aspects can move one or more containers to another virtual machine running the same container technology within a cluster of virtual machines to have positive impacts such as resource usage or failure avoidance. As new hosts are added to the host cluster, as container resource requirements change, or when failures are predicted, the movement of containers can be initiated (e.g., dynamically via live migration) to benefit the availability or performance of containers. Aspects of the disclosure can manage multiple container engine technologies such as Docker (trademark of Docker, Inc.), WPARs (IBM's Workload Partitions), OpenVZ (trademark of SWsoft, Inc.), etc. Such capabilities can be integrated into a cloud virtualization management model such that virtual machines for container engines may benefit from placement and maintenance/optimization technologies integrated into the cloud management software.

Software containers may enable rapid building and deployment of applications. Containers and virtual machines may be considered complementary technologies as container engines can run in virtual machines and new virtual machines can be quickly deployed when requested/required. Container technologies may benefit from a capability to perform ongoing maintenance/optimization (e.g., to balance the load as new hardware is added to a cluster, as resource requirements of the container change, as a failure of a host is predicted). Container technologies may also benefit from virtual machine maintenance/optimization and placement rules (e.g., affinity, anti-affinity) performed as part of a cloud management stack at the virtual machine level. Container technologies may benefit from placement logic that can be incorporated across various container engines (Docker, WPARs, etc.).

Aspects of the disclosure include a method, system, and computer program product for managing a shared pool of configurable computing resources. The shared pool of configurable computing resources has a set of physical hosts, a set of virtual machines, and a set of containers. A set of resource usage data for the set of containers is monitored to detect a triggering event which corresponds to the set of resource usage data. Using the set of resource usage data, a container arrangement is determined. The container arrangement indicates a relationship with respect to the set of containers, the set of virtual machines, and the set of physical hosts. In response to both determining the container arrangement and detecting the triggering event, the container arrangement is established.

In embodiments, at least one container of the set of containers includes a plurality of isolated user-space instances which allows for operating-system-level virtualization. In various embodiments, the set of containers includes a first container engine having a first container technology and a second container engine having a second container technology which is different from the first container technology. In embodiments, a container host cluster host group has a set of virtual machine hosts which includes the set of virtual machines. In embodiments, a container host cluster has a first container host that includes a first virtual machine which runs a first container engine. Establishing the container arrangement can include performing a migration (e.g., a live migration) with respect to the set of containers.

In embodiments, cloud management software may recognize and maintain/optimize virtual machines hosting container engines, groups of virtual machines hosting container engines, and relationships to virtual machines and virtual machine hosts. A property for virtual machine images in the cloud management stack can be used to indicate if the image is for a container engine and what the container engine technology is (e.g., Docker, WPAR, OpenVZ). When a new container engine virtual machine is required due to lack of sufficient resource in existing virtual machines, cloud management software can dynamically deploy a new virtual machine using the image. The placement logic can be utilized to filter the hosts to create a new virtual machine on an appropriate host.

The cloud management software can use operations supported for that container technology to monitor the resource usage for the containers for the virtual machines within the container cluster. For example, for Docker there are container level metrics available from cgroups on which Docker is based and virtual machine-wide metrics are possible from systemd-cgtop. If resource usage of a container on one virtual machine is exceeding some defined threshold, the cloud management software may initiate a container live migration of the container to another virtual machine in the container cluster or create a new virtual machine in one of the hosts in the container cluster host group and use the container live migration to move the container into the newly created container host. Likewise, new containers can be placed into existing container hosts or new container hosts based on resource monitoring of the host to determine available capacity and perform fit analysis based on the resource requirements of the container. Altogether, performance or efficiency benefits when managing a shared pool of configurable computing resources which has a set of containers may occur (e.g., speed, flexibility, load balancing, responsiveness, availability, resource usage, productivity). Aspects may save resources such as bandwidth, processing, or memory.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for loadbalancing between clouds).

A cloud computing environment is service oriented with a focus on statelessness, low coupling, modularity, and semantic interoperability. At the heart of cloud computing is an infrastructure comprising a network of interconnected nodes.

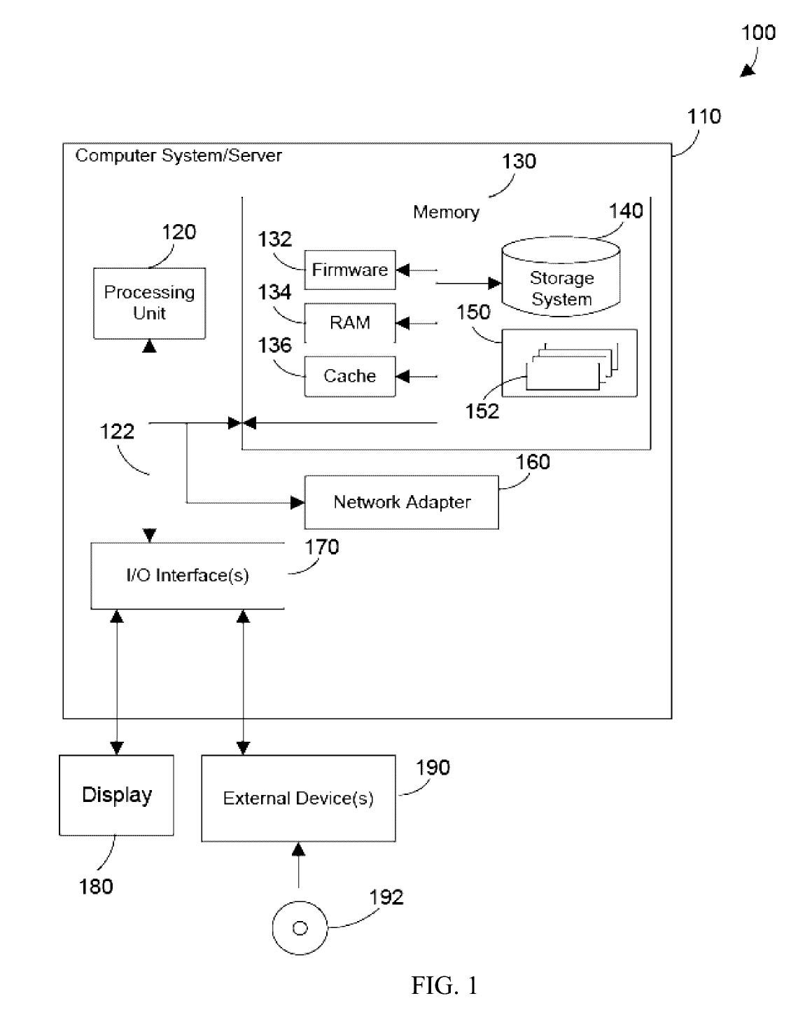

Referring now to FIG. 1, a block diagram of an example of a cloud computing node is shown. Cloud computing node 100 is only one example of a suitable cloud computing node and is not intended to suggest any limitation as to the scope of use or functionality of embodiments of the invention described herein. Regardless, cloud computing node 100 is capable of being implemented and/or performing any of the functionality set forth hereinabove.

In cloud computing node 100 there is a computer system/server 110, which is operational with numerous other general purpose or special purpose computing system environments or configurations. Examples of well-known computing systems, environments, and/or configurations that may be suitable for use with computer system/server 110 include, but are not limited to, personal computer systems, server computer systems, tablet computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 110 may be described in the general context of computer system executable instructions, such as program modules, being executed by a computer system. Generally, program modules may include routines, programs, objects, components, logic, data structures, and so on that perform particular tasks or implement particular abstract data types. Computer system/server 110 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 110 in cloud computing node 100 is shown in the form of a general-purpose computing device. The components of computer system/server 110 may include, but are not limited to, one or more processors or processing units 120, a system memory 130, and a bus 122 that couples various system components including system memory 130 to processing unit 120.

Bus 122 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 110 typically includes a variety of computer system readable media. Such media may be any available media that is accessible by computer system/server 110, and it includes both volatile and non-volatile media, removable and non-removable media. An example of removable media is shown in FIG. 1 to include a Digital Video Disc (DVD) 192.

System memory 130 can include computer system readable media in the form of volatile or non-volatile memory, such as firmware 132. Firmware 132 provides an interface to the hardware of computer system/server 110. System memory 130 can also include computer system readable media in the form of volatile memory, such as random access memory (RAM) 134 and/or cache memory 136. Computer system/server 110 may further include other removable/non-removable, volatile/non-volatile computer system storage media. By way of example only, storage system 140 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 122 by one or more data media interfaces. As will be further depicted and described below, memory 130 may include at least one program product having a set (e.g., at least one) of program modules that are configured to carry out the functions described in more detail below.

Program/utility 150, having a set (at least one) of program modules 152, may be stored in memory 130 by way of example, and not limitation, as well as an operating system, one or more application programs, other program modules, and program data. Each of the operating system, one or more application programs, other program modules, and program data or some combination thereof, may include an implementation of a networking environment. Program modules 152 generally carry out the functions and/or methodologies of embodiments of the invention as described herein.

Computer system/server 110 may also communicate with one or more external devices 190 such as a keyboard, a pointing device, a display 180, a disk drive, etc.; one or more devices that enable a user to interact with computer system/server 110; and/or any devices (e.g., network card, modem, etc.) that enable computer system/server 110 to communicate with one or more other computing devices. Such communication can occur via Input/Output (I/O) interfaces 170. Still yet, computer system/server 110 can communicate with one or more networks such as a local area network (LAN), a general wide area network (WAN), and/or a public network (e.g., the Internet) via network adapter 160. As depicted, network adapter 160 communicates with the other components of computer system/server 110 via bus 122. It should be understood that although not shown, other hardware and/or software components could be used in conjunction with computer system/server 110. Examples, include, but are not limited to: microcode, device drivers, redundant processing units, external disk drive arrays, Redundant Array of Independent Disk (RAID) systems, tape drives, data archival storage systems, etc.

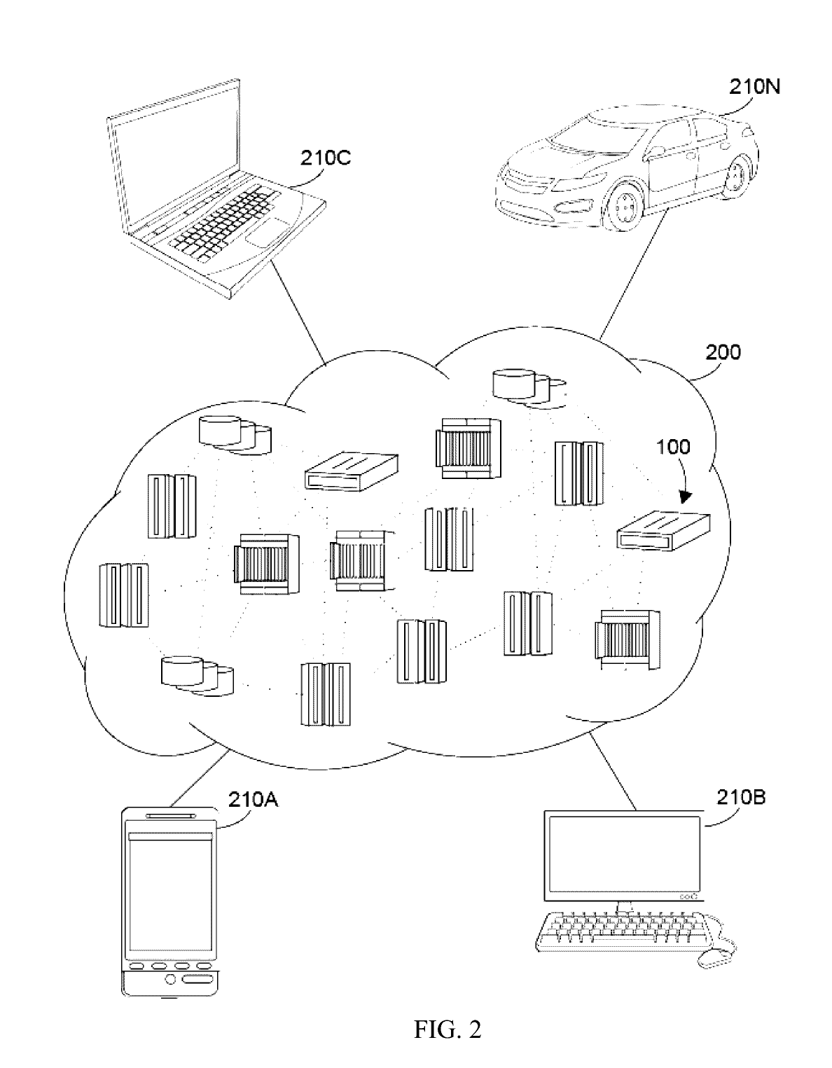

Referring now to FIG. 2, illustrative cloud computing environment 200 is depicted. As shown, cloud computing environment 200 comprises one or more cloud computing nodes 100 with which local computing devices used by cloud consumers, such as, for example, personal digital assistant (PDA) or cellular telephone 210A, desktop computer 210B, laptop computer 210C, and/or automobile computer system 210N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 200 to offer infrastructure, platforms and/or software as services for which a cloud consumer does not need to maintain resources on a local computing device. It is understood that the types of computing devices 210A-N shown in FIG. 2 are intended to be illustrative only and that computing nodes 100 and cloud computing environment 200 can communicate with any type of computerized device over any type of network and/or network addressable connection (e.g., using a web browser).

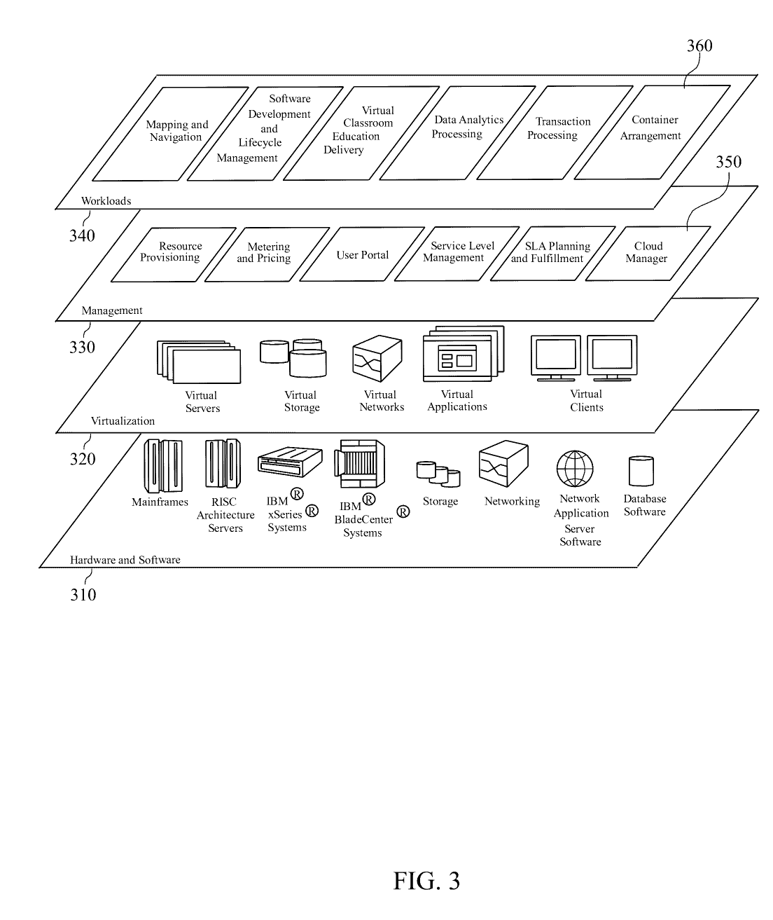

Referring now to FIG. 3, a set of functional abstraction layers provided by cloud computing environment 200 in FIG. 2 is shown. It should be understood in advance that the components, layers, and functions shown in FIG. 3 are intended to be illustrative only and the disclosure and claims are not limited thereto. As depicted, the following layers and corresponding functions are provided.

Hardware and software layer 310 includes hardware and software components. Examples of hardware components include mainframes, in one example IBM System z systems; RISC (Reduced Instruction Set Computer) architecture based servers, in one example IBM System p systems; IBM System x systems; IBM BladeCenter systems; storage devices; networks and networking components. Examples of software components include network application server software, in one example IBM WebSphere® application server software; and database software, in one example IBM DB2® database software. IBM, System z, System p, System x, BladeCenter, WebSphere, and DB2 are trademarks of International Business Machines Corporation registered in many jurisdictions worldwide.

Virtualization layer 320 provides an abstraction layer from which the following examples of virtual entities may be provided: virtual servers; virtual storage; virtual networks, including virtual private networks; virtual applications and operating systems; and virtual clients.

In one example, management layer 330 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. A cloud manager 350 is representative of a cloud manager (or shared pool manager) as described in more detail below. While the cloud manager 350 is shown in FIG. 3 to reside in the management layer 330, cloud manager 350 can span all of the levels shown in FIG. 3, as discussed below.

Workloads layer 340 provides examples of functionality for which the cloud computing environment may be utilized. Examples of workloads and functions which may be provided from this layer include: mapping and navigation; software development and lifecycle management; virtual classroom education delivery; data analytics processing; transaction processing; and a container arrangement 360, which may be used as discussed in more detail below.

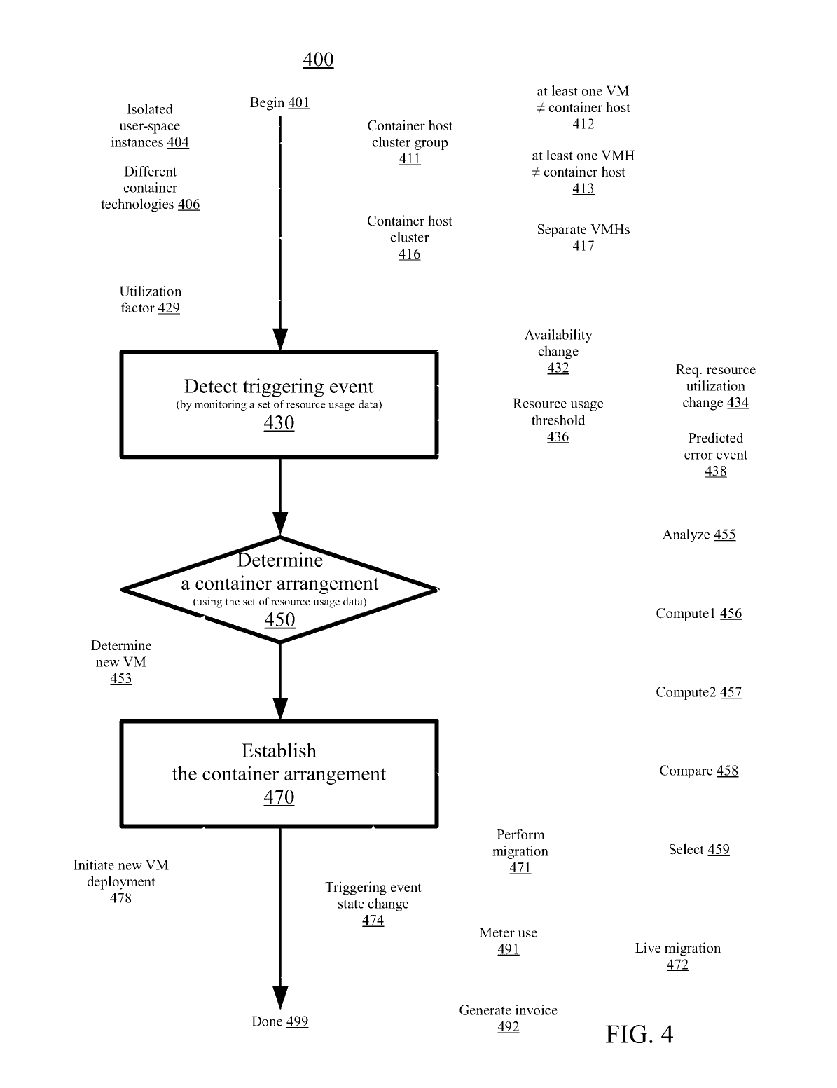

FIG. 4 is a flowchart illustrating a method 400 for managing a shared pool of configurable computing resources having a set of physical hosts, a set of virtual machines, and a set of containers according to embodiments. The shared pool of configurable computing resources may utilize a shared pool manager (e.g., a controller, a cloud manager) to execute/carry-out processes/tasks (e.g., manage assets using method 400). The shared pool manager may or may not be included in the shared pool of configurable computing resources. Method 400 may begin at block 401.

The set of containers can be used to run multiple isolated systems on a single host. Put differently, the set of containers can share a single operating system and, optionally, other binary and library resources. While the set of containers may run the same kernel as the host, they can optionally run a different package tree or distribution. The kernel may manage memory and filesystem access the same way as if it were running on the host system. Containers may be considered lightweight relative to virtual machines (e.g., by potentially not including persistent files or state). It is possible for containers to run inside of other containers. At least one container of the set of containers may have a plurality of isolated user-space instances which can allow for operating-system-level virtualization at block 404. Operating-system-level virtualization, in which multiple isolated containers run on a single instance of an operating system, may be considered distinct from system-level virtualization. In system-level virtualization, one or more virtual machines can be instantiated at a software level on a physical computer (host computer or host), such that each virtual machine runs its own operating system instance.

Aspects of the disclosure can manage multiple container engine technologies such as Docker (trademark of Docker, Inc.), WPARs (IBM's Workload Partitions), OpenVZ (trademark of SWsoft, Inc.), etc. For example Docker technology can include (https://docs.docker.com/introduction/understanding-docker/) or (https://en.wikipedia.org/wiki/Docker_%28software%29), the content of each of which is incorporated by reference in its entirety. In embodiments, the set of containers includes a first container engine having a first container technology and a second container engine having a second container technology which is different from the first container technology at block 406. As such, one or more container technologies may be run on the same host or different hosts. In certain embodiments, a first container of the first container technology may be run inside of a second container of the second container technology.

In embodiments, the shared pool of configurable computing resources (having the set of physical hosts, the set of virtual machines, and the set of containers) may include a container host cluster host group at block 411. The container host cluster host group can have a set of virtual machine hosts (e.g., the set of physical hosts) which includes the set of virtual machines. As such, the container host cluster host group has hosts of container hosts (e.g., the virtual machine hosts) which can be grouped together. The container host cluster host group may define one or more hosts of virtual machines which include container hosts that are a part of a container host cluster. A container host cluster includes one or more container hosts (a container host may include a virtual machine which runs a container engine) and can be used for placement and ongoing performance impacts (e.g., maintenance/optimization) of containers.

In embodiments, the set of virtual machine hosts has a virtual machine host that includes a virtual machine which is not a container host at block 412. For example, the virtual machine host may have four virtual machines where three virtual machines are container hosts and one virtual machine is not a container host. In embodiments, the set of virtual machine hosts has a virtual machine host that is without a container host. For example, the virtual machine host may have zero container hosts (e.g., but can have one or more virtual machines). The virtual machine host may be included in the container host cluster host group (e.g., without a container host).

In embodiments, the shared pool of configurable computing resources (having the set of physical hosts, the set of virtual machines, and the set of containers) may include a container host cluster at block 416. The container host cluster can have a first container host that includes a first virtual machine which runs a first container engine. For example, one or more container hosts can have one or more virtual machines running one or more container engines (e.g., 4 container hosts with 12 virtual machines running 24 container engines). In embodiments, the container host cluster has a second container host that includes a second virtual machine which runs a second container engine. Accordingly, a first virtual machine host may include the first virtual machine and a second virtual machine host may include the second virtual machine. In certain embodiments, the first virtual machine host is separate (e.g., physically separate, different physical hosts) from the second virtual machine host (e.g., but may be part of one container host cluster).

A set of resource usage data may be present, received, collected, or stored. The set of resource usage data may be for (e.g., associated with) the set of containers. For example, the set of resource usage data may indicate utilization or health of the set of containers (e.g., with respect to historical/current/predicted events/processes/operations). The set of resource usage data for the set of containers may include a utilization factor at block 429. The utilization factor can include a processor utilization factor, a memory utilization factor, a disk utilization factor, or a network utilization factor. For instance, metrics for container, virtual machine hosts, or virtual machines may be used or analyzed (e.g., based on processor/memory/disk/network: usage-percentages, gross-usage, tasks, inputs, outputs, available shares, relative weights, performance speeds). Various data analysis techniques can be performed (e.g., comparisons of data with threshold values, calculations with respect to available capacity, fit computations with respect to resource requirements of specific containers).

At block 430, a triggering event is detected (e.g., by monitoring a set of resource usage data for the set of containers). In embodiments, monitoring the set of resource usage data for the set of containers may include a set of observations or identifications. For instance, monitoring can include querying (e.g., asking a question), searching (e.g., exploring for a reason), obtaining (e.g., recording a collection), probing (e.g., checking a property), scanning (e.g., reviewing a sample), or tracking (e.g., following a characteristic). Detecting can include sensing, measuring a change, or an identification (e.g., by scanning and identifying).

The triggering event corresponds to the set of resource usage data. As such, a detection with respect to the set of resource usage data may occur to initiate the triggering event. The triggering event may include a change in availability associated with both the set of containers and the set of virtual machines at block 432 (e.g., addition/removal of a component such as a new host being added to a host cluster). The triggering event can include a change in requested resource utilization for the set of containers at block 434 (e.g., as container resource requirements change such as processor/memory load modifications). The triggering event may include a resource usage threshold being met at block 436 (e.g., reaching a processor/memory load level). The triggering event can include a predicted error event at block 438 (e.g., a failure forecast with respect to a host).

At block 450, a container arrangement is determined using the set of resource usage data. The container arrangement indicates a relationship with respect to the set of containers, the set of virtual machines, and the set of physical hosts. The container arrangement may include a configuration for deployment/placement of various virtual machines (e.g., to one or more hosts), and container instantiation with respect to the various virtual machines. The relationship or the configuration can include information/linkages for which assets (containers, virtual machines, virtual machine hosts) having what capacities/resources that are online at which locations for certain temporal periods or particular purposes. The nature of how the assets are connected may change at varying stages, and each stage may have its own container arrangement (some container arrangements may be similar or the same). As such, container arrangements may be defined in terms the set of containers, the set of virtual machines, and the set of physical hosts (e.g., including at least one dependency of an asset on another asset). For example, one physical host may have four virtual machines on which seven containers are spread.

In embodiments, determining the container arrangement includes determining to initiate deployment of a new virtual machine at block 453 (e.g., the set of resource usage data indicates a threshold/ceiling has been met and more resources may be beneficial, performance may benefit by spreading resources across more virtual machines). In embodiments, determining the container arrangement using the set of resource usage data includes a set of operations. The set of resource usage data may be analyzed at block 455. For instance, analyzing can include extracting (e.g., creating a derivation), examining (e.g., performing an inspection), scanning (e.g., reviewing a sample), evaluating (e.g., generating an appraisal), dissecting (e.g., scrutinizing an attribute), resolving (e.g., ascertaining an observation/conclusion/answer), parsing (e.g., deciphering a construct), querying (e.g., asking a question), searching (e.g., exploring for a reason/ground/motivation), comparing (e.g., relating an assessment), classifying (e.g., assigning a designation), or categorizing (e.g., organizing by a feature). Data analysis may include a process of inspecting, cleaning, transforming, or modeling data to discover useful information, suggest conclusions, or support decisions. Data analysis can extract information/patterns from a data set and transform/translate it into an understandable structure (e.g., a data report which can be provided/furnished) for further use.

The set of resource usage data may be analyzed to identify/ascertain a set of candidate container arrangements (e.g., both a first candidate container arrangement and a second candidate container arrangement). A first expected resource usage for the first candidate container arrangement can be computed at block 456 (e.g., anticipated processor/memory utilization). A second expected resource usage for the second candidate container arrangement can be computed at block 457. The first and second expected resource usages may be compared at block 458. Based on the second expected resource usage exceeding the first expected resource usage, the first candidate container arrangement may be selected (e.g., for lower anticipated processor/memory utilization with other inputs being effectively equivalent). Accordingly, in certain embodiments more or fewer sets of virtual machines or sets of containers may be implemented in a given container arrangement derived from the set of candidate container arrangements.

At block 470, the container arrangement is established. The container arrangement can be established in response to determining the container arrangement or detecting the triggering event. In embodiments, establishing the container arrangement includes initiating deployment of a new virtual machine using an image associated with a container technology related to the triggering event at block 478. For example, if the triggering event is related to a particular container technology, the new virtual machine may increase the availability of that container technology by deploying the new virtual machine to have the particular container technology. The image may be stored on and retrieved from a host having the container technology related to triggering event. In certain embodiments, establishing the container arrangement can include rearranging a previous container arrangement (e.g., without a new virtual machine).

In embodiments, establishing the container arrangement includes performing a migration with respect to the set of containers at block 471 (e.g., moving a container from one virtual machine to another or from one host to another). In various embodiments, the migration includes a live migration at block 472. A live migration can include moving a running virtual machine or container between different hosts without an interrupt/disconnection. Memory, storage, network connectivity, etc. may be transferred from the original to the destination. For example, a running container can be captured and placed elsewhere. Accordingly, ongoing maintenance/optimization or balancing of container workloads may occur. In certain embodiments, establishing the container arrangement changes a state of the triggering event at block 473 (e.g., a threshold is no longer met because more resources are available due to establishment of the container arrangement).

Use of the container arrangement may be metered at block 491. For example, the container arrangement may be measured based on factors such as quantity of assets allocated, temporal periods of allocation, actual usage of assets, available usage of assets, etc. Such factors may correlate to charge-back or cost burdens which can be defined in-advance (e.g., utilizing usage tiers) or scaled with respect to a market-rate. An invoice or bill presenting the usage, rendered services, fee, and other payment terms may be generated based on the metered use at block 492. The generated invoice may be provided (e.g., displayed in a dialog box, sent or transferred by e-mail, text message, traditional mail) to the user for notification, acknowledgment, or payment.

Method 400 concludes at block 499. Aspects of method 400 may provide performance or efficiency benefits for managing a shared pool of configurable computing resources. For example, aspects of method 400 may have positive impacts when using a set of containers (e.g., related to a container arrangement). Altogether, performance or efficiency benefits for utilization of a set of physical hosts, a set of virtual machines, and a set of containers may occur (e.g., speed, flexibility, load balancing, responsiveness, availability, resource usage, productivity).

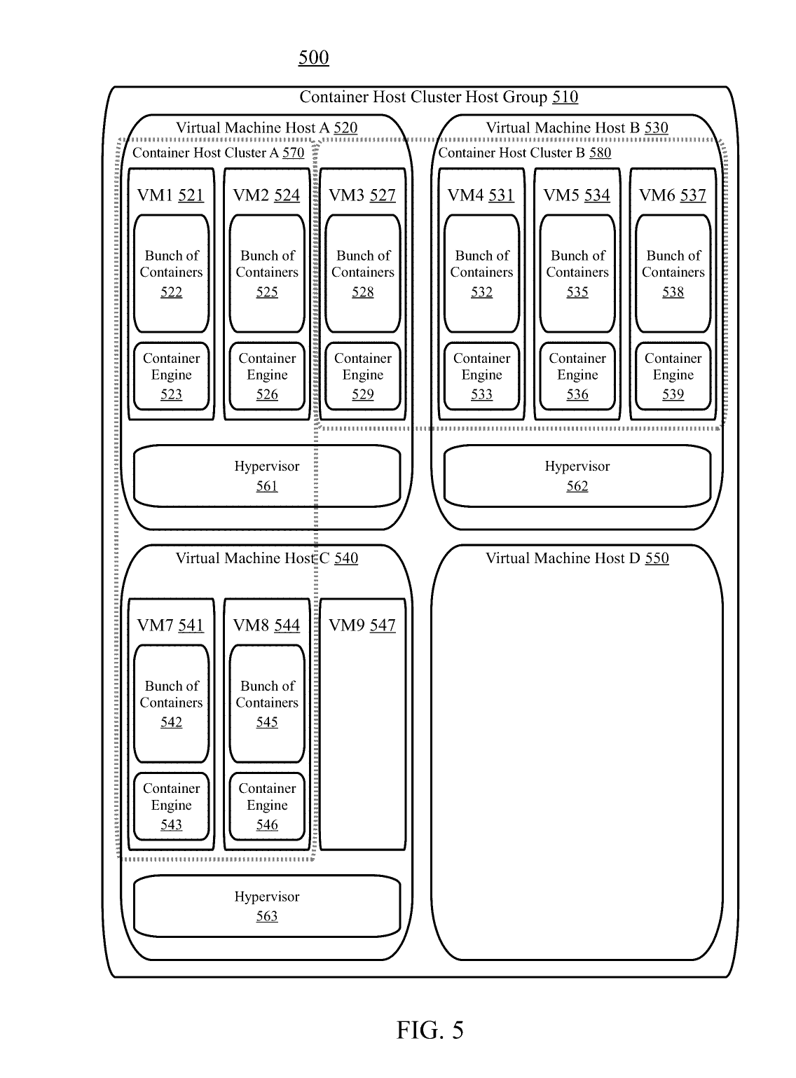

FIG. 5 shows an example system 500 having a set of virtual machine hosts (e.g., a set of physical hosts), a set of virtual machines, and a set of containers according to embodiments. In embodiments, method 400 may be implemented using aspects described with respect to the example system 500. As such, aspects of the discussion related to FIG. 4 and method 400 may be used or applied in the example system 500. Components depicted in FIG. 5 need not be present, utilized, or located as such in every such similar system, and such components are presented as an illustrative example. Aspects of example system 500 may be implemented in hardware, software or firmware executable on hardware, or a combination thereof. The example system 500 can be operated in a shared pool of configurable computing resources (e.g., the cloud environment) on a set of physical hosts. Of course, example system 500 could include many other features or functions known in the art that are not shown in FIG. 5.

Container Host Cluster Host Group 510 includes a set of hosts (virtual machine hosts A 520, B 530, C 540, and D 550). The set of hosts (e.g., set of physical hosts) has a set of virtual machines and a hypervisor. Virtual Machine Host A 520 includes a hypervisor 561 and virtual machines 521, 524, 527. Virtual machines 521, 524, 527 have a bunch of containers (e.g., one or more containers) 522, 525, 528 and a container engine 523, 526, 529. Virtual Machine Host B 530 includes a hypervisor 562 and virtual machines 531, 534, 537. Virtual machines 531, 534, 537 have a bunch of containers 532, 535, 538 and a container engine 533, 536, 539. Virtual Machine Host C 540 includes a hypervisor 563 and virtual machines 541, 544, 547. Virtual machines 541, 544, 547 have a bunch of containers 542, 545 and a container engine 543, 546.

Virtual machines which host container engines may be described as Container Hosts. Virtual machine 549 may not include a container or a container engine in the depicted container arrangement (but could in other container arrangements). Virtual Machine Host D 550 may not include any virtual machines in the depicted container arrangement (but could in other container arrangements such as if a new virtual machine is required to meet the resource requirements of a Container Host Cluster, the new virtual machine could be created on Virtual Machine Host D or one of the others). There are two groupings of container hosts depicted. Container Host Cluster A 570 includes virtual machines 521, 524, 541, 544. Container Host Cluster B 580 includes virtual machines 527, 531, 534, 537. Container Host Clusters can be within the same virtual machine host or across different virtual machine hosts (as shown). Container Host Clusters can have the same or different container technologies (e.g., Cluster A could be Docker and Cluster B could be WPAR) which can have positive performance or efficiency benefits for workload flexibility/diversity in a mixed data center.

Accordingly, a set of resource usage data (e.g., stored in association with the shared pool manager—see FIG. 1-3) for the set of containers is monitored to detect a triggering event which corresponds to the set of resource usage data. Using the set of resource usage data, a container arrangement (such as that of example system 500) is determined. The container arrangement indicates a relationship with respect to the set of containers, the set of virtual machines, and the set of physical hosts. In response to both determining the container arrangement and detecting the triggering event, the container arrangement is established (e.g., as depicted in example system 500).

For example, a utilization factor (e.g., processor utilization percentage as a function of processor capacity) in a set of resource data for a specific set of containers using a specific container technology is monitored by the shared pool manager. The triggering event may be detected when the utilization factor exceeds a threshold value (e.g., processor utilization percentage exceeds 80% for a given temporal period). Based on the set of resource usage data, a new container arrangement can be determined which can provide additional processor resources for the specific container technology and related to the specific set of containers (e.g., determine to add a new virtual machine with processing resources which can be made part of a new specific set of containers regardless of the physical host having the new virtual machine). The new container arrangement can be established consistent with the determination. Accordingly, a migration (e.g., live migration) can occur which places a particular container of the specific set of containers on the new virtual machine (as such, the new specific set of containers can be indicated). Thus, the new container arrangement may provide performance or efficiency benefits (e.g., with respect to processor utilization).

In addition to embodiments described above, other embodiments having fewer operational steps, more operational steps, or different operational steps are contemplated. Also, some embodiments may perform some or all of the above operational steps in a different order. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

Embodiments of the present disclosure may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

1. A system for managing a shared pool of configurable computing resources having a set of physical hosts, a set of virtual machines, and a set of containers, the system comprising:
a memory having a set of computer readable computer instructions, and
a processor for executing the set of computer readable instructions, the set of computer readable instructions including:
detecting, by monitoring a set of resource usage data for the set of containers, a triggering event which corresponds to the set of resource usage data;
determining, using the set of resource usage data, a container arrangement which indicates a relationship with respect to the set of containers, the set of virtual machines, and the set of physical hosts; and
establishing, in response to both determining the container arrangement and detecting the triggering event, the container arrangement.

2. (canceled)

3. The system of claim 1, wherein the set of containers includes:
a first container engine having a first container technology; and
a second container engine having a second container technology which is different from the first container technology.

4. The system of claim 1, wherein determining the container arrangement includes:
determining to add, in addition to a set of existing virtual machines, a new virtual machine;
determining to initiate deployment of the new virtual machine; and
wherein establishing the container arrangement includes:
creating, in addition to the set of existing virtual machines, the new virtual machine;
initiating deployment of the new virtual machine using an image associated with a container technology related to the triggering event.

5. The system of claim 1, wherein the shared pool of configurable computing resources having the set of physical hosts, the set of virtual machines, and the set of containers includes:
a container host cluster host group having a set of virtual machine hosts which includes the set of virtual machines, wherein a first virtual machine host of the set of virtual machine hosts is physically separate from a second virtual machine host of the set of virtual machine hosts, and wherein a cloud environment includes the container host cluster group.

6. (canceled)

7. (canceled)

8. The system of claim 1, wherein the shared pool of configurable computing resources having the set of physical hosts, the set of virtual machines, and the set of containers includes:
a container host cluster having a first container host that includes:
a first virtual machine which has a first container engine of a first container technology; and
a second virtual machine which has a second container engine of a second container technology which is different from the first container technology.

9. The system of claim 8, wherein a first virtual machine host includes the first virtual machine, wherein a second virtual machine host includes the second virtual machine, and wherein the first virtual machine host is physically separate from the second virtual machine host, and further comprising:
performing, using the container arrangement, ongoing maintenance and balancing of container workloads.

10. The system of claim 1, wherein establishing the container arrangement includes:
performing a first live migration with respect to a first container technology of the set of containers; and
performing a second live migration with respect to a second container technology of the set of containers, wherein the first container technology is different from the second container technology.

11. The system of claim 10, wherein at least one live migration includes migrating one or more containers to a newly created container host.

12. The system of claim 1, wherein establishing the container arrangement changes a state of the triggering event which corresponds to the set of resource usage data for the set of containers, wherein the set of resource usage data for the set of containers is different in response to establishing the container arrangement.

13. The system of claim 1, wherein the set of resource usage data for the set of containers includes:
a processor utilization factor for the set of containers,
a memory utilization factor for the set of containers,
a disk utilization factor for the set of containers, and
a network utilization factor for the set of containers.

14. (canceled)

15. The system of claim 1, wherein determining, using the set of resource usage data, the container arrangement which indicates the relationship with respect to the set of containers, the set of virtual machines, and the set of physical hosts includes:
analyzing the set of resource usage data for the set of containers;
identifying a set of candidate container arrangements including both a first candidate container arrangement and a second candidate container arrangement;
computing, with respect to the set of containers a first expected resource usage for the first candidate container arrangement;
computing, with respect to the set of containers a second expected resource usage for the second candidate container arrangement;
comparing the first and second expected resource usages; and
selecting, based on the second expected resource usage exceeding the first expected resource usage, the first candidate container arrangement.

16. (canceled)

17. (canceled)

18. A computer program product for managing a shared pool of configurable computing resources having a set of physical hosts, a set of virtual machines, and a set of containers, the computer program product comprising a computer readable storage medium having program instructions embodied therewith, wherein the computer readable storage medium is not a transitory signal per se, the program instructions executable by a processor to cause the processor to perform a method comprising:
detecting, by monitoring a set of resource usage data for the set of containers, a triggering event which corresponds to the set of resource usage data;
determining, using the set of resource usage data, a container arrangement which indicates a relationship with respect to the set of containers, the set of virtual machines, and the set of physical hosts; and
establishing, in response to both determining the container arrangement and detecting the triggering event, the container arrangement.

19-20. (canceled)

21. The system of claim 1, wherein the triggering event includes a change in availability associated with both the set of containers and the set of virtual machines.

22. The system of claim 1, wherein the triggering event includes a change in requested resource utilization for the set of containers.

23. The system of claim 1, wherein the triggering event includes a resource usage threshold being met.

24. The system of claim 1, wherein the triggering event includes a predicted error event.

25. The system of claim 1, wherein the set of resource usage data for the set of containers indicates utilization of the set of containers.

26. The system of claim 1, wherein the set of resource usage data for the set of containers indicates health of the set of containers.

27. The system of claim 1, wherein monitoring the set of resource usage data for the set of containers includes:
tracking, using the set of resource usage data for the set of containers, a characteristic of the set of containers.

28. The system of claim 1, wherein determining, using the set of resource usage data, the container arrangement includes:
analyzing, with respect to the set of containers, the set of resource usage data for the set of containers; and
resolving, with respect to the set of containers, to use a different number of virtual machines for the set of containers.
